(19) United States
(12) Patent Application Publication
(10) Pub. No.: US 2015/0226875 A1
(43) Pub. Date: Aug. 13, 2015

(54) Single Sensor for Detecting Neutrons and Gamma Rays

(71) Applicant: GE Oil & Gas Logging Services, Inc., Houston, TX (US)

(72) Inventors: Helene Claire Climent, Sugar Land, TX (US); Alok Mani Srivastava, Niskayuna, NY (US); Wusheng Xu, ShangHai (CN); Jiyuan Liu, Twinsburg, OH (US); Adam Paul Graebner, Sugar Land, TX (US)

(73) Assignee: GE Oil & Gas Logging Services, Inc., Houston, TX (US)

(21) Appl. No.: 14/179,057

(22) Filed: Feb. 12, 2014

(51) Int. Cl. G01V 5/14; G01T 3/06; G01V 5/10; G01T 1/202

(52) U.S. Cl. CPC G01V 5/145; G01T 1/202; G01T 3/06; G01V 5/107

(57) ABSTRACT

A logging system for imaging a subterranean formation that includes radiation sources that emit different energy levels of radiation into the formation. The radiation scatters from the formation and is sensed by a single sensor that is responsive to the different energy levels of radiation. The single sensor includes a crystal which includes cesium, lithium, yttrium, cerium, and chlorine. The radiation sources emit neutron rays and gamma rays.

### BACKGROUND OF THE INVENTION

1. Field of Invention

The present disclosure relates in general to a single sensor for detecting neutrons and gamma rays. More specifically, the present disclosure relates to a tool for evaluating subterranean formations that includes a sensor that detects both neutrons and gamma rays.

2. Description of Prior Art

Subterranean hydrocarbon producing formations are typically interrogated by scanning the formation from within a wellbore that intersects the formation. Well logging is one type of scanning where a tool is lowered within the wellbore, while signals and/or radiation are emitted from the tool and into the surrounding formation. The tool is also typically equipped with receivers for sensing reflections of the signals/radiation from the strata making up the formation. Analyzing the sensed reflections can yield information used to estimate the location and quantity of potential oil and gas reserves that can be extracted from downhole via the wellbore. The information generally includes formation permeability, porosity, bound fluid volume, formation pressure and temperature, and resistivity. Some downhole tools are equipped to receive reflections where the originating signal is emitted from above the formation, such as on the sea floor, sea surface, or on dry land.

The signals generated and received downhole are electromagnetic, radioactive, or acoustic. Well logging with radiation typically involves a radiation source in the downhole tool with one or more receivers spaced axially away from the source. A collimator is sometimes provided adjacent the source to direct the radiation into the formation at a designated angle so that the scattered radiation can be sensed by the receiver. Scintillators are sometimes used to sense the scattered radiation, and which have material that exhibits scintillates in response to being contacted by the scattered radiation. The light emitted is then transformed into an electrical signal. The term “count” is often used to describe each occurrence of scattered radiation contacting a scintillator. Values for formation porosity and density are sometimes estimated by analyzing the number of counts over a period of time. Accordingly, scintillators having material that exhibit a greater luminescence provide more accurate downhole measurements.

### SUMMARY OF THE INVENTION

Disclosed herein is an example of a logging tool for imaging a subterranean formation and a method of imaging the formation. In an example the logging tool includes a source of neutrons that selectively emits neutrons into the formation that scatter from the formation and a sensor that is selectively disposed in a wellbore that intersects the formation. The sensor includes a crystal having cesium, lithium, yttrium, cerium, and chlorine, and that is spaced away from the source of neutrons, so that when the neutrons are emitted into the formation, the sensor is in the path of the scattered neutrons and senses the scattered neutrons. The logging tool can further include a source of gamma rays that scatter from the formation and are sensed by the sensor. In an example, the crystal includes matter having the general chemical formula of Cs₂LiY_{X}Ce_{1-X}Cl₆, where X ranges from 0.95 to 0.995. Alternatively, the crystal has matter with the general chemical formula of Cs₂⁶LiY_{X}Ce_{1-X}Cl₆, where X ranges from 0.95 to 0.995. Optionally included is a crystal housing having a window disposed over and open end, and wherein the crystal is cylindrical and is disposed coaxially within the crystal housing. In this example, the window can be quartz, sapphire, or combinations thereof. A controller can be included that is in communication with the sensor.

Also disclosed herein is a method of well logging in a borehole that intersects a subterranean formation, where the example includes providing a scintillator crystal in the borehole that comprises cesium, lithium, yttrium, cerium, and chlorine; emitting gamma-rays and neutrons from within the tool into the formation and that scatter from the formation; and detecting neutrons that scatter from the formation and gamma rays with the scintillator crystal. Gamma rays may optionally be directed into the formation, and which scatter from the formation and detecting gamma rays that scatter from the formation. The scintillator crystal can have the general chemical formula of comprising Cs₂LiY_{X}Ce_{1-X}Cl₆ or Cs₂⁶LiY_{X}Ce_{1-X}Cl₆; where X ranges from 0.95 to 0.995. A sonde may optionally be provided for housing the scintillator crystal, a source of neutrons, and a source of gamma rays. The sonde may optionally be moved to different depths in the wellbore while monitoring neutrons and gamma rays detected by the scintillator crystal. The temperature in the wellbore can exceed 175° C.

Further disclosed herein is an example of a downhole tool for imaging a subterranean formation and which includes a source of neutrons in a housing that is selectively disposed downhole, a source of gamma rays in the housing, and a detector in the housing for detecting neutrons and gamma rays that scatter from the formation and that comprises a cesium halide crystal. The crystal can have the general chemical formula comprising Cs₂LiY_{X}Ce_{1-X}Cl₆ or Cs₂⁶LiY_{X}Ce_{1-X}Cl₆, where X ranges from 0.95 to 0.995.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example of a logging system with a logging tool disposed in a wellbore and in accordance with the present invention.

FIG. 2 is a partial sectional view of an example of a portion of the logging tool of FIG. 1 and in accordance with the present invention.

FIG. 3 is a side sectional view of an example of a crystal for use with the portion of the logging tool of FIG. 2 and in accordance with the present invention.

FIG. 4 is an example plot representing scattered radiation sensed by the logging system of FIG. 1 and in accordance with the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

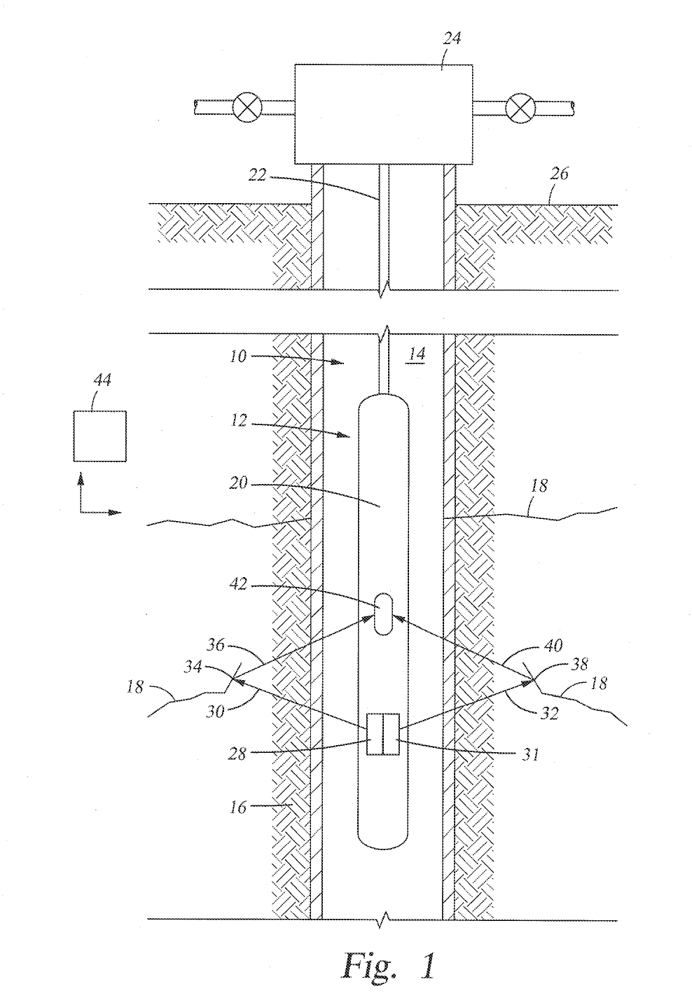

Shown in partial side sectional view in FIG. 1 is an example of a logging system 10 that includes an elongated logging tool 12 disposed in a wellbore 14. The wellbore 14 projects through a subterranean formation 16, shown having fractures 18 and other discontinuities in its strata. The tool 12 includes a housing 20 that is suspended within the wellbore 14 on a wireline 22 that routes through a wellhead assembly 24 on surface 26. Schematically illustrated with the tool 12 is a neutron source 28 that provides neutrons 30 that are emitted into the formation 16. Optionally included with the tool 12 is a gamma ray source 31 that provides gamma rays 32 shown being projected into the formation 16. In the illustrated example, the neutrons 30 from the neutron source 28 scatter from a point 34 in the formation 16 to define scattered neutrons 36; where the point 34 may coincide with a fracture 18 or other discontinuity. Similarly, the gamma rays 32 from the gamma ray source 31 are illustrated scattering from point 38 to define scattered gamma rays 40; where point 36 can be a fracture 18 or other discontinuity in the formation 16. The scattered neutrons 36 and scattered gamma rays 40 are illustrated intersecting a detector 42 provided with the tool 12. As will be described in more detail below, the detector 42 can sense both the scattered neutrons 36 and scattered gamma rays 40.

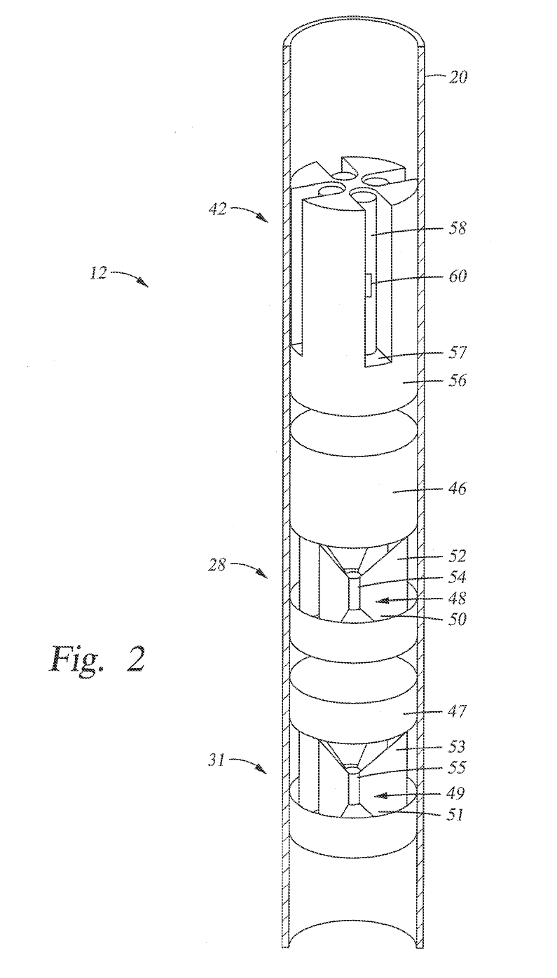

A portion of the tool 12 is shown in a side and partial perspective view in FIG. 2. In this example, the neutron source 28 and gamma ray source 31 are illustrated housed in the housing 20. The neutron source 28 includes a body 45 having a window 46, and a radioactive material 47 disposed within the body 45. In one example, the source 47 is made from AmBe. The gamma ray source 31 includes a body 48 with a recess 49 formed therein; and a collimator 50 in the recess 49. Fins 51 extend axially within the recess 49. In the illustrated embodiment, radioactive material 55 is provided in the body 48 where the fins 51 join one another. In an example, radioactive material 55 may optionally include ¹³³Ba, ¹³⁷Cs, or both.

Still referring to FIG. 2, a detailed example of detector 42 is shown in the housing 20 and spaced axially away from neutron source 28 on a side opposite gamma ray source 31. The embodiment of the detector 42 shown includes a cylindrically shaped detector body 56 with slots 57 extending axially along a portion of its outer surface. Detector elements 58 are illustrated set in the slots 57, where each element 58 includes a scintillator crystal 60 for detecting the scattered neutrons and gamma rays 36, 40 (FIG. 1). Alternate embodiments exist having a greater or fewer number of slots 57 with elements 58, and elements 58 need not necessarily be set in the slots 57. As is known, the scintillator crystal 60 reemits the absorbed radiation in the form of light. In one embodiment, the scintillator crystal 60 is a cesium halide crystal. Alternatively, the scintillator crystal 60 includes cesium (Cs), lithium (Li), yttrium (Y), cerium (Ce), chlorine (Cl), and combinations thereof. In one non-limiting example, the scintillator crystal 60 includes matter having the general chemical formula of Cs₂LiY_{X}Ce_{1-X}Cl₆. In another alternative, the general chemical formula of the matter making up a part of or all of the scintillator crystal 60 is Cs₂⁶LiY_{X}Ce_{1-X}Cl₆. In each of the example chemical formulas X can range from about 0.95 to about 0.995. A photomultiplier tube 61 may be coupled to the crystal 60 to convert the light from the scintillation crystal 60 to measurable electron current or voltage pulse, which is then used to quantify the energy of each detected gamma ray.

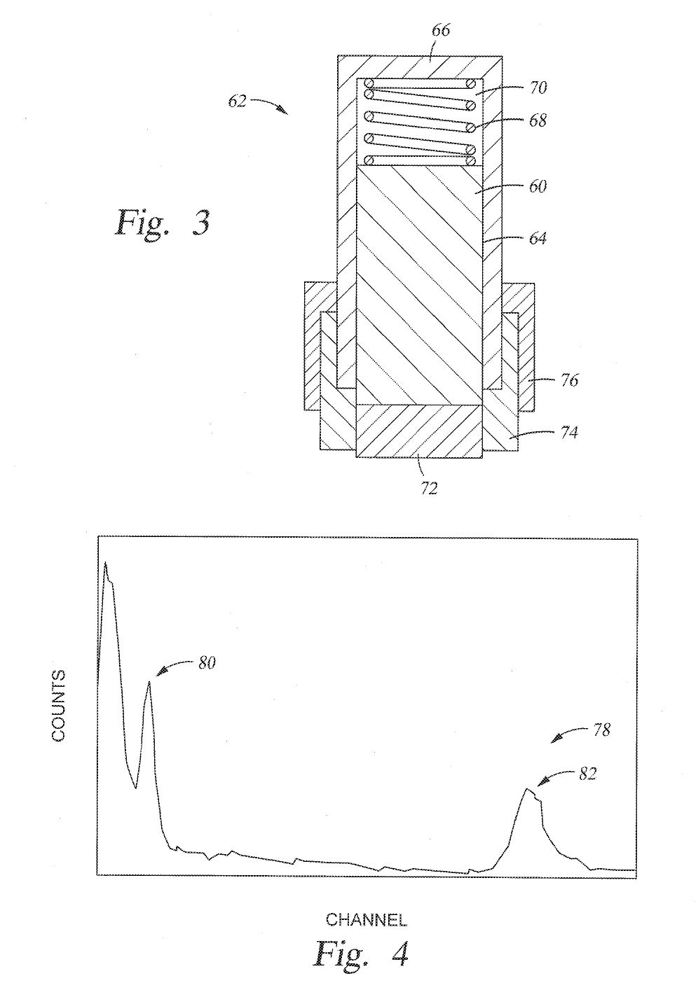

Referring now to FIG. 3 an example of a scintillator crystal package 62 is shown in a side cross sectional view for packaging the crystal 60 when disposed in the detector element 58 (FIG. 2). The scintillator crystal package 62 as illustrated includes a tape covering 64 on an outer side of the crystal 60 that can be made from polytetrafluroethylene (PTFE). Further in the example of FIG. 3, a case 66 is shown having a cylindrically shaped chamber 68 and in which the crystal 60 is housed. A spring 70 is optionally provided in a portion of the chamber 68 not occupied by the crystal 60 which biases crystal 60 towards an open end of case 66 and away from a closed end of case 66. A window 72 covers the open end of case, where window 72 can be made from quartz, sapphire, or any other suitable material. In the example shown, an end of crystal 60 distal from spring 70 is adjacent an inward facing side of window 72. The open end of case 66 and window 72 are circumscribed by an annular lower housing 74. Optionally, a threaded connection couples case 66 and lower housing 74, where a sealant 76 (such as a parafilm) covers an interface along the threaded connection.

In one non-limiting example of operation, tool 12 (FIG. 1) is moved axially (up or down) within wellbore 14 while neutrons 30 and gamma rays 32 from the neutron and gamma ray sources 28, 31 scatter from the formation 16 and define scattered neutrons and gamma rays 36, 40; some of which are intercepted by the scintillator crystal 60 (FIG. 2). As noted above, the scintillator crystal 60 is responsive to both neutrons and gamma rays. As detection of scattered neutrons 36 (FIG. 1) can provide information about porosity of the formation 16, and detection of scattered gamma rays 40 can provide information about density of the formation 16, an advantage of the logging system 10 described herein is that both porosity and density of the formation 16 can be estimated in a single trip downhole and using a single tool. Examples exist wherein a temperature in the wellbore 14 exceeds 175° C.

Referring now to FIG. 4, an example plot 78 is illustrated that reflects counts (ordinate) vs. channel (abscissa), where counts represents incidences of recorded radiation, and channel represents a corresponding energy of the recorded radiation. Peak 80 shows recorded radiation at an energy level corresponding to gamma rays and peak 82 shows recorded radiation at an energy level corresponding to neutrons. In an example, signals from the scintillator crystal 60 (FIG. 3) are filtered and processed in order to identify the quantity of scattered neutrons and gamma rays 36, 40 that encounter the scintillator crystal 60. Knowing the count rates and peak resolution, the porosity and density of the formation 16 can be estimated.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A logging tool for imaging a subterranean formation comprising:
a source of neutrons that selectively emits neutrons into the formation that scatter from the formation;
a sensor that is selectively disposed in a wellbore that intersects the formation and that comprises,
a crystal having cesium, lithium, yttrium, cerium, and chlorine, and that is spaced away from the source of neutrons, so that when the neutrons are emitted into the formation, the sensor is in the path of the scattered neutrons and senses the scattered neutrons.

2. The logging tool of claim 1, further comprising a source of gamma rays that scatter from the formation and are sensed by the sensor.

3. The logging tool of claim 1, wherein the crystal comprises matter having the general chemical formula comprising Cs₂LiY_{X}Ce_{1-X}Cl₆, where X ranges from 0.95 to 0.995.

4. The logging tool of claim 1, wherein the crystal comprises matter having the general chemical formula comprising Cs₂⁶LiY_{X}Ce_{1-X}Cl₆, where X ranges from 0.95 to 0.995.

5. The logging tool of claim 1, further comprising a crystal housing having a window disposed over and open end, and wherein the crystal is cylindrical and is disposed coaxially within the crystal housing.

6. The logging tool of claim 5, wherein the window comprises a material selected from the group consisting of quartz, sapphire, and combinations thereof.

7. The logging tool of claim 1, further comprising a photomultiplier tube in communication with the sensor.

8. A method of well logging in a borehole that intersects a subterranean formation comprising:
providing a scintillator crystal in the borehole that comprises cesium, lithium, yttrium, cerium, and chlorine;
directing neutrons from within the borehole into the formation and that scatter from the formation; and
detecting neutrons that scatter from the formation and gamma rays with the scintillator crystal.

9. The method of claim 8, further comprising directing gamma rays into the formation that scatter from the formation and detecting gamma rays that scatter from the formation.

10. The method of claim 8, wherein the scintillator crystal comprises matter having the general chemical formula comprising Cs₂LiY_{X}Ce_{1-X}Cl₆, where X ranges from 0.95 to 0.995.

11. The method of claim 8, wherein the scintillator crystal comprises matter having the general chemical formula comprising Cs₂⁶LiY_{X}Ce_{1-X}Cl₆, where X ranges from 0.95 to 0.995.

12. The method of claim 8, further comprising providing a sonde for housing the scintillator crystal, a source of neutrons, and a source of gamma rays.

13. The method of claim 12, further comprising moving the sonde to different depths in the wellbore while monitoring neutrons and gamma rays detected by the scintillator crystal.

14. The method of claim 8, wherein temperature in the wellbore is in excess of 175° C.

15. A logging tool for imaging a subterranean formation comprising:
a source of neutrons in a housing that is selectively disposed downhole;
a source of gamma rays in the housing; and
a detector in the housing for detecting neutrons and gamma rays that scatter from the formation and that comprises a cesium halide crystal.

16. The logging tool of claim 15, wherein the crystal comprises matter having the general chemical formula comprising Cs₂LiY_{X}Ce_{1-X}Cl₆, where X ranges from 0.95 to 0.995.

17. The logging tool of claim 15, wherein the crystal comprises matter having the general chemical formula comprising Cs₂⁶LiY_{X}Ce_{1-X}Cl₆, where X ranges from 0.95 to 0.995.
